(19) United States
(12) Patent Application Publication
(10) Pub. No.: US 2012/0254001 A1
(43) Pub. Date: Oct. 4, 2012

(54) METHOD AND SYSTEM FOR PROVIDING AN AGREEMENT WITNESS SERVICE

(76) Inventor: Alexander S. Ran, Palo Alto, CA (US)

(21) Appl. No.: 13/073,590

(22) Filed: Mar. 28, 2011

(51) Int. Cl. G06F 15/16; G06Q 40/00

(52) U.S. Cl. 705/35; 709/227

(57) ABSTRACT

A method and system for providing an agreement witness service whereby when two parties desire to enter into an agreement/transaction, a first party provides contact data for a first party computing system and the second party sends an “agreement acknowledgement request message” to a witness service provider system. The witness service provider system then generates an agreement code and attaches the agreement code to the agreement acknowledgement request message, thereby transforming the agreement acknowledgement request message into an “agreement acknowledgement message”. The agreement acknowledgement message is then sent to the first party. The first party then provides the agreement code to the second party and the agreement code is stored as evidence of the first party's acknowledgement of the agreement/transaction.

### BACKGROUND

In many parts of the world, and particularly in areas having developing/emerging economies, individuals, such as consumers and merchants, particularly small business merchants, often engage in informal credit arrangements involving low value transactions, and other types of informal agreements.

For instance, in many parts of Asia, the Middle East, and some European countries, it is a common practice for neighborhood merchants, such as convenience or grocery store owners, to informally extend credit to their regular customers. In these situations, when a customer makes credit purchases from the merchant, the merchant typically writes down the value of the purchases made by a customer in a notebook, ledger, or other largely hand written means of recording transactions, and associates the handwritten entry with the customer. In many cases, all that is recorded is the amount of the purchase and the customer's name.

Typically, multiple purchases are made by the customer over a period time under these informal credit arrangements and then, once the total balance the customer owes reaches certain amount, or on some periodic basis, the customer is requested to make a payment, and/or pay off the balance owed.

In the situation described above, not only are the amounts/balances often too small to justify formal processes for agreement and management, such as a contract or other written promise to pay from the customer, but, in many cultures where these informal credit arrangements are used, more formal mechanisms/documents would be considered by the customers to be an insult, i.e., an indication of a lack of trust in the customer on the part of the merchant. This can be particularly problematic because in many areas where these informal credit arrangements are used, maintaining trust, mutual respect, and a personal relationship, is critical for obtaining and keeping customers.

Despite the emphasis on trust in many of the areas, and cultures, where informal credit arrangements, are common, currently, largely due to the informal nature of the record keeping, and the lack of any formal acknowledgement on the part of the customer regarding the amount owed and the items purchased, arguments and disputes quite commonly result at the time the customer's payment is requested by the merchant. Consequently, the risk involved with transactions conducted using these informal credit arrangements is far higher than the risk associated with other more formalized transactions.

In addition, manually entering and keeping track of individual purchases made by multiple customers over a period of time can be quite burdensome for the merchant extending the informal credit and is, arguably, unduly subject to human error and malfeasance. However, in many emerging economies, the cost of currently available data management or accounting systems is prohibitive and, in many cases, the infrastructure required to implement any computing system and/or Internet-based, point-of-sale, or other data management system, does not exist.

As a result of the situation described above, many merchants in areas where informal credit arrangements are common are forced to endure not only the burden of manually recording customer purchases, but also the arguments, disputes, and write offs, associated with trying to collect a balance owed by a customer that was never formally acknowledged by the customer.

In addition, also as a result of the situation described above, many parties in areas where informal agreements, other than informal credit arrangements, are commonly used, are also left with no tangible evidence of the parties' acknowledgement of an agreement, and therefore these parties must also endure the arguments, disputes, and write offs, associated with these kind of informal agreements.

### SUMMARY

In accordance with one embodiment, a method and system for providing an agreement witness service includes a process for providing an agreement witness service whereby, in one embodiment, a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”. In one embodiment, the first party provides the second party contact data for the first party, such as, but not limited to, a phone number, e-mail address, or other contact information, that will be used to send one or more messages, such as, but not limited to, a Short Message Service (SMS) message, Instant Message (IM), e-mail message, or other form of communication, to a computing system, such as but not limited to, a mobile telephone or other mobile computing system, associated with the first party.

In one embodiment, at the time of the agreement/transaction, the second party sends an “agreement acknowledgement request message” to a witness service provider, or other trusted third party. In one embodiment, the agreement acknowledgement request message includes a direct or indirect representation of the agreement/transaction and the contact data for the first party.

In one embodiment, when the witness service provider receives the agreement acknowledgement request message, the witness service provider generates an agreement code, typically a one-time use code, and attaches the agreement code to the agreement acknowledgement request message, thereby transforming the agreement acknowledgement request message into an “agreement acknowledgement message”. In one embodiment, the agreement acknowledgement message is sent to the computing system associated with the first party using the contact data for the first party.

In one embodiment, when the first party receives the agreement acknowledgement message including the agreement code, the first party provides the agreement code to the second party and the agreement code is stored, or otherwise maintained, by the second party, and/or the witness service provider, as evidence of the first party's acknowledgement of the agreement/transaction.

Using the method and system for providing an agreement witness service discussed herein, parties desiring to enter into an agreement are provided a lightweight and simple mechanism for recording their acknowledgement of the agreement through a trusted, and disinterested, third party witness service provider. Therefore, using the method and system for providing an agreement witness service discussed herein, the acknowledgement of the agreement/transaction by both parties is recorded for use as evidence, if needed, but neither party needs to take the time and energy to manually record the agreement/transaction.

In addition, using the method and system for providing an agreement witness service discussed herein, the acknowledgement, and/or proof, of the agreement is provided without overly formal or burdensome promissory, and/or contract-like, mechanisms that, in some regions and cultures, would indicate a lack of trust and therefore interfere with personal business relationships.

In addition, one embodiment of the method and system for providing an agreement witness service discussed herein is implemented using an SMS communication infrastructure capable of being accessed and used through mobile devices, such as mobile phones, which are far more common and accessible in many parts of the world than traditional computing systems and Internet access. Consequently, the method and system for providing an agreement witness service discussed herein can be utilized even in parts of the world where traditional Internet access is not available.

As a result, using the method and system for providing an agreement witness service discussed herein, much of the risk associated with current informal agreements/transactions can be eliminated while still preserving the flexibility and personal trust elements that are critical to traditional, and time-honored, informal agreement/transaction methods.

As discussed in more detail below, using the below embodiments, with little or no modification and/or user/consumer input, there is considerable flexibility, adaptability, and opportunity for customization to meet the specific needs of various users/consumers under numerous circumstances.

### BRIEF DESCRIPTION OF THE DRAWINGS

FIG. 1 is a block diagram of an exemplary hardware architecture for implementing one embodiment;

FIG. 2 is a flow chart depicting a process for providing an agreement witness service in accordance with one embodiment; and

FIG. 3 is a flow chart depicting an SMS-based process for providing an agreement witness service in accordance with one embodiment.

Common reference numerals are used throughout the FIGS. and the detailed description to indicate like elements. One skilled in the art will readily recognize that the above FIGS. are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be embodied in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

In accordance with one embodiment, a method and system for providing an agreement witness service includes a process for providing an agreement witness service whereby, in one embodiment, a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”.

In one embodiment, the first party provides the second party first party contact data for the first party, such as, but not limited to, a phone number, e-mail address, or other contact information, that will be used to send one or more messages, such as, but not limited to, a Short Message Service (SMS) message, Instant Message (IM), e-mail message, or other form of communication, to a first party computing system associated with the first party.

Herein, the term computing system includes, but is not limited to, any computing system known in the art at the time of filing, and/or as developed after the time of filing, such as, but not limited to: a mobile computing system; a desktop computing system; a laptop computing system; a notebook computing system; a workstation; a two-way pager; a cellular telephone; a smart phone; a digital wireless telephone; a Personal Digital Assistant (PDA); a server computer; an Internet appliance, any other device, or any desired combination of these devices, that includes components that can execute all, or part, of a process for providing an agreement witness service in accordance with at least one of the embodiments as discussed herein, and/or as known in the art at the time of filing, and/or as developed after the time of filing.

Herein, the term “mobile computing system” includes, but not limited to: a mobile phone; a smart phone; an internet appliance; any SMS capable system; or any other mobile computing system as discussed herein, and/or as known in the art at the time of filing, and/or as developed after the time of filing.

In one embodiment, at the time of the agreement/transaction, the second party sends an “agreement acknowledgement request message” from a second party computing system associated with the second party to a witness service provider system, or a computing system associated with another trusted third party.

In one embodiment, the agreement acknowledgement request message includes a direct representation of the agreement/transaction, such as a number/amount associated with the agreement/transaction or a short statement of the agreement/transaction in text format.

In one embodiment, the agreement acknowledgement request message includes an indirect representation of the agreement/transaction such as a fixed length, one-way function transformation of the text of the agreement, such as a “hashed” transformation of the text of the agreement. In one embodiment, the indirect representation is generated by a software application on the second party's computing system.

One advantage to providing a one-way function transformation of the text of the agreement is that it becomes computationally infeasible to change the text of the agreement and still maintain the same hash value. Therefore, in these instances, the parties can be confident that the representation of the agreement is the same, and the terms are the same, as those they originally agreed to, and acknowledged.

In one embodiment, the agreement acknowledgement request message includes the first party contact data for the first party.

In one embodiment, when the agreement acknowledgement request message is received by the witness service provider system, one or more processors associated with the witness service provider system analyze the agreement acknowledgement request message and identify the first party contact data included in the agreement acknowledgement request message.

In one embodiment, when the agreement acknowledgement request message is received by the witness service provider system, one or more processors associated with the witness service provider system generate a unique agreement code or symbol, typically a one-time use code or symbol, such as a string of alpha-numeric characters or symbols, and associate the generated agreement code with the agreement acknowledgement request message.

In one embodiment, one or more processors associated with the witness service provider system attach the agreement code to the agreement acknowledgement request message, thereby transforming the agreement acknowledgement request message into an “agreement acknowledgement message”.

In one embodiment, the agreement acknowledgement message is sent to the first party computing system associated with the first party using the first party contact data.

In one embodiment, when the first party computing system, and therefore the first party, receives the agreement acknowledgement message including the agreement code, the first party provides the agreement code to the second party.

In one embodiment, the agreement code is provided visually and/or verbally to the second party. In one embodiment, the agreement code is provided to the second party as agreement code data representing the agreement code. In various embodiments, the agreement code is presented/transferred to the second party using any means, method, process, and/or procedure, and/or any combination of means, methods, processes, and/or procedures, of providing codes and/or data, as discussed herein, and/or as known in the art at the time of filing, and/or as developed after the time of filing.

In one embodiment, the agreement code, and/or agreement code data, is stored, or otherwise maintained, by the second party as evidence of the acknowledgement of the agreement/transaction by the first party.

In one embodiment, the agreement code, and/or agreement code data, is stored, or otherwise maintained, by the first party as evidence of the acknowledgement of the agreement/transaction by the first party.

In one embodiment, the agreement code, and/or agreement code data, is sent back to the witness service provider system by the second party, and/or the first party, and the agreement code, and/or agreement code data, is then stored, or otherwise maintained, by the witness service provider as evidence of the acknowledgement of the agreement/transaction by the first party.

In one embodiment, the agreement code, and/or agreement code data, is stored by any of the parties as evidence of the acknowledgement of the agreement/transaction by the first party in a database such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In various embodiments, should a disagreement arise regarding the agreement or transaction at a future date, the agreement code, and/or agreement code data, is retrieved, along with, in one embodiment, the agreement acknowledgement message and/or the agreement/transaction representation, to be used as evidence of the agreement/transaction and/or the acknowledgement of the agreement/transaction by the first party.

In various embodiments, when the agreement acknowledgement request message includes a representation of the agreement/transaction that allows the witness service provider, and/or one or more processors associated with the witness service provider system, to analyze the semantics of the message, the witness service provider offers additional services to either the first party or the second party. In one embodiment, the additional services include, but are not limited to: the current balance the first party owes to the second party; a listing of all, or part, of the historical agreements/transactions between the two parties; any terms, such as a payment, or action, or date associated with one or more agreements/transactions between the two parties; a payment amount associated with one or more agreements/transactions between the two parties; and/or any other agreement/transaction related items and/or terms associated with one or more agreements/transactions between the two parties.

On the other hand, to preserve the privacy of the parties, in some embodiments, the agreement acknowledgement request message and/or agreement acknowledgement message is an opaque token that carries no discernable meaning for the witness service provider, and/or one or more processors associated with the witness service provider system. As noted above, in some embodiments, the agreement acknowledgement request message includes an indirect representation of the agreement/transaction such as a fixed length, one-way function transformation of the text of the agreement, such as a “hashed” transformation of the text of the agreement, and this process yields the private opaque token feature.

In some embodiments, the agreement acknowledgement request message is sent by the second party to a different witness service provider system, or receiving unit, associated with the witness service provider depending on the type of agreement/transaction involved.

As an example, in one embodiment, a different witness service provider system, or receiving unit, or code, is established by the witness service provider for different types of agreements/transactions such as store credit, order of goods or service, equipment lease, etc.

Alternatively, in some embodiments, a single witness service provider system, or receiving unit, or code, is used for all kinds of agreements/transactions and further differentiation is achieved by explicit analysis and classification of the body of the agreement acknowledgement request message by the witness service provider system.

In addition, one embodiment of the method and system for providing an agreement witness service discussed herein is implemented using an SMS communication infrastructure capable of being accessed and used through mobile devices, such as mobile phones, which are far more common and accessible in many parts of the world than traditional computing systems and Internet access. Consequently, the method and system for providing an agreement witness service discussed herein can be utilized even in parts of the world where traditional Internet access is not available.

In accordance with this embodiment, a method and system for providing an agreement witness service includes a process for providing an agreement witness service via SMS whereby, in one embodiment, a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”.

In one embodiment, the first party provides the second party a mobile phone number for the first party that will be used to send one or more Short Message Service (SMS) messages to a SMS capable first party mobile computing system associated with the first party.

Herein, the term “mobile computing system” includes, but not limited to: a mobile phone; a smart phone; an internet appliance; any SMS capable system; or any other mobile computing system as discussed herein, and/or as known in the art at the time of filing, and/or as developed after the time of filing capable of receiving SMS message traffic.

In one embodiment, at the time of the agreement/transaction, the second party sends an “agreement acknowledgement request SMS message” from a SMS capable second party mobile computing system associated with the second party to a witness service provider system, or a computing system associated with another trusted third party, via SMS.

In one embodiment, the agreement acknowledgement request SMS message includes a direct representation of the agreement/transaction, such as a number/amount associated with the agreement/transaction or a short statement of the agreement/transaction in SMS text format.

In one embodiment, the agreement acknowledgement request SMS message includes an indirect representation of the agreement/transaction such as a fixed length, one-way function transformation of the text of the agreement, such as a “hashed” transformation of the text of the agreement in SMS format. In one embodiment, the indirect representation is generated by a software application on the second party's computing system.

One advantage to providing a one-way function transformation of the text of the agreement is that it becomes computationally infeasible to change the text of the agreement and still maintain the same hash value. Therefore, in these instances, the parties can be confident that the representation of the agreement is the same, and the terms are the same, as those they originally agreed to, and acknowledged.

In one embodiment, the agreement acknowledgement request SMS message includes the first party mobile phone number for the first party mobile computing system.

In one embodiment, when the agreement acknowledgement request SMS message is received by the witness service provider system, one or more processors associated with the witness service provider system analyze the agreement acknowledgement request SMS message and identify the first party mobile phone number included in the agreement acknowledgement request SMS message.

In one embodiment, when the agreement acknowledgement request SMS message is received by the witness service provider system, one or more processors associated with the witness service provider system generate a unique agreement code or symbol, typically a one-time use code or symbol, such as a string of alpha-numeric characters or symbols, and associate the generated agreement code with the agreement acknowledgement request SMS message.

In one embodiment, one or more processors associated with the witness service provider system attach the agreement code to the agreement acknowledgement request SMS message, thereby transforming the agreement acknowledgement request SMS message into an “agreement acknowledgement SMS message”.

In one embodiment, the agreement acknowledgement SMS message is sent to the first party mobile computing system associated with the first party using the first party mobile phone number.

In one embodiment, when the first party mobile computing system, and therefore the first party, receives the agreement acknowledgement SMS message including the agreement code, the first party provides the agreement code to the second party.

In one embodiment, the agreement code is provided visually and/or verbally to the second party. In one embodiment, the agreement code is provided to the second party as agreement code data representing the agreement code. In various embodiments, the agreement code is presented/transferred to the second party using any means, method, process, and/or procedure, and/or any combination of means, methods, processes, and/or procedures, of providing codes and/or data, as discussed herein, and/or as known in the art at the time of filing, and/or as developed after the time of filing.

In one embodiment, the agreement code, and/or agreement code data, is stored, or otherwise maintained, by the second party as evidence of the acknowledgement of the agreement/transaction by the first party.

In one embodiment, the agreement code, and/or agreement code data, is stored, or otherwise maintained, by the first party as evidence of the acknowledgement of the agreement/transaction by the first party.

In one embodiment, the agreement code, and/or agreement code data, is sent back to the witness service provider system by the second party, and/or the first party, via an SMS message and the agreement code, and/or agreement code data, is then stored, or otherwise maintained, by the witness service provider as evidence of the acknowledgement of the agreement/transaction by the first party.

In one embodiment, the agreement code, and/or agreement code data, is stored by any of the parties as evidence of the acknowledgement of the agreement/transaction by the first party in a database such as any database as defined herein, and/or known at the time of filing, and/or as developed thereafter.

In various embodiments, should a disagreement arise regarding the agreement or transaction at a future date, the agreement code, and/or agreement code data, is retrieved, along with, in one embodiment, the agreement acknowledgement message and/or the agreement/transaction representation, to be used as evidence of the agreement/transaction and/or the acknowledgement of the agreement/transaction by the first party.

In various embodiments, when the agreement acknowledgement request SMS message includes a representation of the agreement/transaction that allows the witness service provider, and/or one or more processors associated with the witness service provider system, to analyze the semantics of the message, the witness service provider offers additional services to either the first party or the second party. In one embodiment, the additional services include, but are not limited to: the current balance the first party owes to the second party; a listing of all, or part, of the historical agreements/transactions between the two parties; any terms, such as a payment, or action, or date associated with one or more agreements/transactions between the two parties; a payment amount associated with one or more agreements/transactions between the two parties; and/or any other agreement/transaction related items and/or terms associated with one or more agreements/transactions between the two parties.

On the other hand, to preserve the privacy of the parties, in some embodiments, the agreement acknowledgement request SMS message and/or agreement acknowledgement SMS message is an opaque token that carries no discernable meaning for the witness service provider, and/or one or more processors associated with the witness service provider system. As noted above, in some embodiments, the agreement acknowledgement request SMS message includes an indirect representation of the agreement/transaction such as a fixed length, one-way function transformation of the text of the agreement, such as a “hashed” transformation of the text of the agreement in SMS format, and this process yields the private opaque token feature.

In some embodiments, the agreement acknowledgement request SMS message is sent by the second party to a different short code associated with the witness service provider system depending on the type of agreement/transaction involved.

As an example, in one embodiment, a different short code is established by the witness service provider for different types of agreements/transactions such as store credit, order of goods or service, equipment lease, etc.

Alternatively, in some embodiments, a single short code is used for all kinds of agreements/transactions and further differentiation is achieved by explicit analysis and classification of the body of the agreement acknowledgement request SMS message by the witness service provider system.

As a specific illustrative example of the implementation and use of one embodiment of a process for providing an agreement witness service, assume a local convenience store, i.e., a merchant, in South-East Asia is willing to extend a credit to a customer.

In this specific illustrative example, the customer provides the merchant a mobile phone number for the customer and, at the time of the agreement/transaction, the merchant sends an “agreement acknowledgement request SMS message” to a witness service provider system via SMS.

In this specific example, the agreement acknowledgement request SMS message includes a direct or indirect representation of the agreement/transaction and the customer mobile phone number for the customer mobile computing system in SMS text format. In one embodiment, the agreement acknowledgement request SMS message includes simply the first party's identification, the customer's phone number, and an amount associated with the agreement/transaction.

In this specific example, when the agreement acknowledgement request SMS message is received by the witness service provider system, the customer mobile phone number included in the agreement acknowledgement request SMS message is identified and a unique agreement code is generated and associated with the agreement acknowledgement request SMS message.

In this specific example, the agreement code is then attached to the agreement acknowledgement request SMS message, thereby transforming the agreement acknowledgement request SMS message into an “agreement acknowledgement SMS message”, and the agreement acknowledgement SMS message is sent to the customer mobile computing system using the customer mobile phone number.

In this specific example, when the customer receives the agreement acknowledgement SMS message including the agreement code, the customer provides the agreement code to the merchant and the agreement code is stored, or otherwise maintained, by any, or all, of the parties as evidence of the acknowledgement of the agreement/transaction by the customer.

### Hardware System Architecture

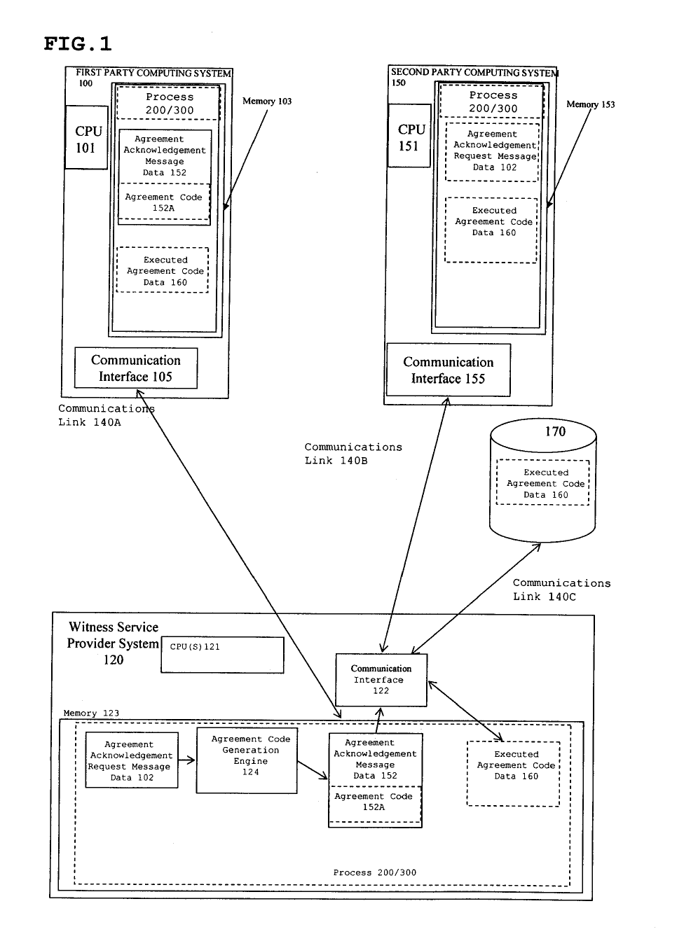

FIG. 1 is a block diagram of an exemplary hardware architecture for implementing one embodiment of a system and method for providing an agreement witness service, such as exemplary processes 200 and/or 300, discussed herein, that includes: a first party computing system 100, e.g., a customer or “accepting party: computing system; a second party computing system 150, e.g., a merchant or “proposing party” computing system; a witness service provider system 120, e.g., a witness service provider or “trusted third party” computing system; an executed agreement code database 170, e.g., a database; a communications link 140A, e.g., a first communications link; a communications link 140B, e.g., a second communications link; and communications link 140C, e.g., a third communications link.

As seen in FIG. 1, first party computing system 100 typically includes a central processing unit (CPU) 101, a communications interface 105, and a memory system 103. In one embodiment, memory system 103 includes all, or part of, a process for providing an agreement witness service 200/300.

In one embodiment, memory system 103 includes all, or part of, agreement acknowledgement message data 152, representing an agreement acknowledgement message sent from witness service provider system 120 and including agreement code 152A.

In one embodiment, memory system 103 includes all, or part of, executed agreement code data 160 that is, in one embodiment, stored/maintained by the first party in memory system 103 after the agreement code 152A is provided to the second party.

In one embodiment, first party computing system 100 is a mobile computing system such as, but not limited to: a mobile phone; a smart phone; an internet appliance; any SMS capable system; or any other mobile computing system as discussed herein, and/or as known in the art at the time of filing, and/or as developed after the time of filing.

In one embodiment, first party computing system 100 is any computing system discussed herein, and/or as known in the art at the time of filing, and/or as developed after the time of filing that includes components that can execute all, or part, of process for providing an agreement witness service 200/300 in accordance with at least one of the embodiments as described herein.

In various embodiments, first party computing system 100 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, first party computing system 100, whether available or known at the time of filing or as later developed.

In one embodiment, process for providing an agreement witness service 200/300 is entered, in whole, or in part, into first party computing system 100 via an I/O device (not shown), such as from a CD, DVD, floppy disk, portable hard drive, memory stick, download site, or other medium and/or computer program product as defined herein.

As also seen in FIG. 1, second party computing system 150 typically includes a central processing unit (CPU) 151, a communications interface 155, and a memory system 153. In one embodiment, memory system 153 includes all, or part of, process for providing an agreement witness service 200/300.

In one embodiment, memory system 153 includes all, or part of, agreement acknowledgement request message data 102, representing an agreement acknowledgement request message sent from second party computing system 150 to witness service provider system 120.

In one embodiment, memory system 153 includes all, or part of, executed agreement code data 160 that is, in one embodiment, stored/maintained by the second party in memory system 153 after the agreement code 152A is provided to the second party by the first party.

In one embodiment, second party computing system 150 is a mobile computing system such as, but not limited to: a mobile phone; a smart phone; an internet appliance; any SMS capable system; or any other mobile computing system as discussed herein, and/or as known in the art at the time of filing, and/or as developed after the time of filing.

In one embodiment, second party computing system 150 is any computing system discussed herein, and/or as known in the art at the time of filing, and/or as developed after the time of filing that includes components that can execute all, or part, of process for providing an agreement witness service 200/300 in accordance with at least one of the embodiments as described herein.

In various embodiments, second party computing system 150 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, first party computing system 100, whether available or known at the time of filing or as later developed.

In one embodiment, process for providing an agreement witness service 200/300 is entered, in whole, or in part, into first party computing system 100 via an I/O device (not shown), such as from a CD, DVD, floppy disk, portable hard drive, memory stick, download site, or other medium and/or computer program product as defined herein.

As seen in FIG. 1, in one embodiment, witness service provider system 120 includes one or more processors, CPU(s) 121, a communication interface 122 and a memory 123.

As seen in FIG. 1, in one embodiment, memory 123 includes all, or part of, a process for providing an agreement witness service 200/300.

As seen in FIG. 1, in one embodiment, memory 123, and/or process for providing an agreement witness service 200/300 include agreement acknowledgement request message data 102 that is received from second party computing system 150. As noted above, in one embodiment, at the time of an agreement/transaction, the second party sends an “agreement acknowledgement request message”, including agreement acknowledgement request message data 102, from second party computing system 150 to witness service provider system 120.

As also noted above, in one embodiment, agreement acknowledgement request message data 102 includes a direct representation of the agreement/transaction, such as a number/amount associated with the agreement/transaction or a short statement of the agreement/transaction in text format.

As also noted above, in one embodiment, agreement acknowledgement request message data 102 includes an indirect representation of the agreement/transaction such as a fixed length, one-way function transformation of the text of the agreement, such as a “hashed” transformation of the text of the agreement. In one embodiment, the indirect representation is generated by a software application on the second computing system 150 (not shown).

One advantage to providing a one-way function transformation of the text of the agreement is that it becomes computationally infeasible to change the text of the agreement and still maintain the same hash value. Therefore, in these instances, the parties can be confident that the representation of the agreement is the same, and the terms are the same, as those they originally agreed to, and acknowledged.

As also noted above, in one embodiment, agreement acknowledgement request message data 102 includes the first party contact data for the first party.

As seen in FIG. 1, in one embodiment, memory 123, and/or process for providing an agreement witness service 200/300 include agreement code generation engine 124. As noted above, in one embodiment, when the agreement acknowledgement request message, and agreement acknowledgement request message data 102, is received by witness service provider system 120, one or more processors associated with the witness service provider system, such as CPU(s) 121, analyze the agreement acknowledgement request message data 102 and identify the first party contact data included in agreement acknowledgement request message data 102.

In one embodiment, when the agreement acknowledgement request message data 102 is received by witness service provider system 120, one or more processors associated with witness service provider system 102, and agreement code generation engine 124, generate a unique agreement code 152A, or symbol, typically a one-time use code or symbol, such as a string of alpha-numeric characters or symbols, and associate the generated agreement code 152A with the agreement acknowledgement request message, and agreement acknowledgement request message data 102.

In one embodiment, one or more processors associated with witness service provider system 120 attach the agreement code 152A to the agreement acknowledgement request message data 102, thereby transforming the agreement acknowledgement request message into an “agreement acknowledgement message” and agreement acknowledgement message data 152, and then the agreement acknowledgement message, including agreement acknowledgement message data 152 and agreement code 152A, is sent to first party computing system 100.

In one embodiment, memory system 123 includes all, or part of, executed agreement code data 160 that is, in one embodiment, sent to witness service provider system 120, and stored/maintained by the witness service provider in memory system 123, after the agreement code 152A is provided to the second party by the first party.

In various embodiments, witness service provider system 120 is any computing system discussed herein, and/or as known in the art at the time of filing, and/or as developed after the time of filing that includes components that can execute all, or part, of a process for providing an agreement witness service, in accordance with at least one of the embodiments as described herein.

Also shown in FIG. 1 is executed agreement code database 170. In one embodiment, executed agreement code database 170 is a data storage device, a designated server system or computing system, or a designated portion of one or more server systems or computing systems, such as computing systems 100, 150 and 120, or a distributed database, or an external and/or portable hard drive. In one embodiment, executed agreement code database 170 is a dedicated mass storage device implemented in software, hardware, or a combination of hardware and software. In one embodiment, executed agreement code database 170 is a web-based function.

As discussed in more detail below, in one embodiment, executed agreement code database 170 is under the control of a process for providing an agreement witness service, such as exemplary process 200/300, and includes all, or part of, executed agreement code data 160 that is, in one embodiment, stored/maintained by the a witness service provider after the agreement code 152A is provided to the second party by the first party.

In one embodiment, computing systems 100 and 150, and executed agreement code database 170, are linked to witness service provider system 120 via communications channels 140A, 140B, and 140C, respectively. In various embodiments, any, or all, of communications channels 140A, 140B, and 140C can be, but are not limited to: a mobile communication link, such as a mobile phone link; a land-line phone link; a cable-based communications link; a satellite communications link; the Internet, or other network communications link; and/or any other communications link, or combination of communications links, as discussed herein, and/or as known in the art at the time of filing, and/or as developed after the time of filing.

In various embodiments, any, or all, of communications channels 140A, 140B, and 140C, are any SMS communication link as discussed herein, and/or as known in the art at the time of filing, and/or as developed after the time of filing. Short Message Service (SMS) is the text communication service component of phone, web, or mobile communication systems. SMS uses relatively ridged standardized communications protocols that allow the exchange of only very short text messages between fixed line or mobile phone devices in “SMS format”.

In various embodiments any, or all, of communications channels 140A, 140B, and 140C include any network or network system that is of interest to a consumer such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

In one embodiment, computing systems 100 and 150, executed agreement code database 170, witness service provider system 120, and any, or all, of communications channels 140A, 140B, and 140C, are part of a cloud computing environment.

Those of skill in the art will readily recognize that the components shown in FIG. 1 and their respective sub-components, are shown for illustrative purposes only and that architectures with more or fewer components can implement, and benefit from, the invention. Moreover, one or more components may be located remotely from their respective system and accessed via network, as discussed herein. In addition, the particular type of, and configuration of, computing systems 100, 150, executed agreement code database 170, and witness service provider system 120 are not relevant.

Although a process for providing an agreement witness service, such as process for providing an agreement witness service 200/300, is sometimes referred to herein, alternatively, as a process, an application, a module, a program, a component of a software system, a component of a software package, a component of a parent system, a plug-in, or a feature of a parent system, this terminology is illustrative only. In some embodiments, a process for providing an agreement witness service, such as process for providing an agreement witness service 200/300, is capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as CPU(s) 121.

In one embodiment, a process for providing an agreement witness service, such as process for providing an agreement witness service 200/300, is a computer application or process implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

### Process

In accordance with one embodiment, a method and system for providing an agreement witness service includes a process for providing an agreement witness service whereby, in one embodiment, a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”. In one embodiment, the first party provides the second party contact data for the first party, such as, but not limited to, a phone number, e-mail address, or other contact information, that will be used to send one or more messages, such as, but not limited to, a Short Message Service (SMS) message, Instant Message (IM), e-mail message, or other form of communication, to a computing system, such as but not limited to, a mobile telephone or other mobile computing system, associated with the first party.

In one embodiment, at the time of the agreement/transaction, the second party sends an “agreement acknowledgement request message” to a witness service provider, or other trusted third party. In one embodiment, the agreement acknowledgement request message includes a direct or indirect representation of the agreement/transaction and the contact data for the first party.

In one embodiment, when the witness service provider receives the agreement acknowledgement request message, the witness service provider generates an agreement code, typically a one-time use code, and attaches the agreement code to the agreement acknowledgement request message, thereby transforming the agreement acknowledgement request message into an “agreement acknowledgement message”. In one embodiment, the agreement acknowledgement message is sent to the computing system associated with the first party using the contact data for the first party.

In one embodiment, when the first party receives the agreement acknowledgement message including the agreement code, the first party provides the agreement code to the second party and the agreement code is stored, or otherwise maintained, by the second party, and/or the witness service provider, as evidence of the first party's acknowledgement of the agreement/transaction.

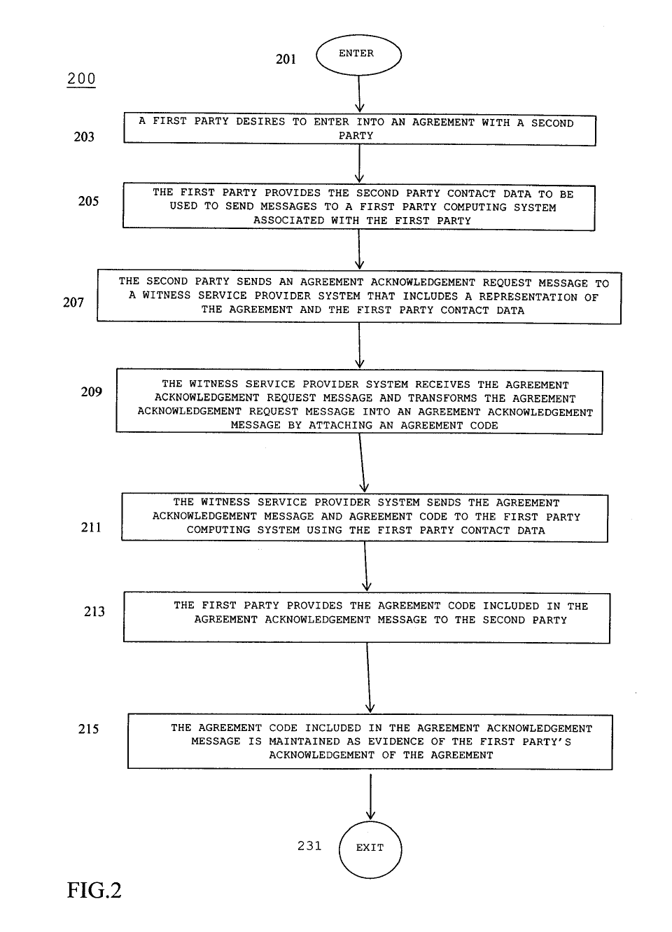

FIG. 2 a flow chart depicting a process for providing an agreement witness service 200 in accordance with one embodiment. Process for providing an agreement witness service 200 begins at ENTER OPERATION 201 of FIG. 2 and process flow proceeds to A FIRST PARTY DESIRES TO ENTER INTO AN AGREEMENT WITH A SECOND PARTY OPERATION 203.

In one embodiment, at A FIRST PARTY DESIRES TO ENTER INTO AN AGREEMENT WITH A SECOND PARTY OPERATION 203 a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”.

In one embodiment, once a first party decides to enter into an agreement/transaction with a second party at A FIRST PARTY DESIRES TO ENTER INTO AN AGREEMENT WITH A SECOND PARTY OPERATION 203 process flow proceeds to THE FIRST PARTY PROVIDES THE SECOND PARTY CONTACT DATA TO BE USED TO SEND MESSAGES TO A FIRST PARTY COMPUTING SYSTEM ASSOCIATED WITH THE FIRST PARTY OPERATION 205.

In one embodiment, at THE FIRST PARTY PROVIDES THE SECOND PARTY CONTACT DATA TO BE USED TO SEND MESSAGES TO A FIRST PARTY COMPUTING SYSTEM ASSOCIATED WITH THE FIRST PARTY OPERATION 205 the first party of A FIRST PARTY DESIRES TO ENTER INTO AN AGREEMENT WITH A SECOND PARTY OPERATION 203 provides the second party of A FIRST PARTY DESIRES TO ENTER INTO AN AGREEMENT WITH A SECOND PARTY OPERATION 203 first party contact data for the first party, such as, but not limited to, a phone number, e-mail address, or other contact information, that will be used to send one or more messages, such as, but not limited to, a Short Message Service (SMS) message, Instant Message (IM), e-mail message, or other form of communication, to a first party computing system associated with the first party.

Herein, the term computing system includes, but is not limited to, any computing system as discussed herein, and/or as known in the art at the time of filing, and/or as developed after the time of filing.

In one embodiment, once the first party provides the second party first party contact data for the first party at THE FIRST PARTY PROVIDES THE SECOND PARTY CONTACT DATA TO BE USED TO SEND MESSAGES TO A FIRST PARTY COMPUTING SYSTEM ASSOCIATED WITH THE FIRST PARTY OPERATION 205, process flow proceeds to THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207.

In one embodiment, at THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207 at the time of the agreement/transaction, the second party sends an “agreement acknowledgement request message” from a second party computing system associated with the second party to a witness service provider system, or a computing system associated with another trusted third party.

In one embodiment, at THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207, the agreement acknowledgement request message includes a direct representation of the agreement/transaction, such as a number/amount associated with the agreement/transaction or a short statement of the agreement/transaction in text format.

In one embodiment, at THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207, the agreement acknowledgement request message includes an indirect representation of the agreement/transaction such as a fixed length, one-way function transformation of the text of the agreement, such as a “hashed” transformation of the text of the agreement. In one embodiment, the indirect representation is generated by a software application on the second party's computing system.

One advantage to providing a one-way function transformation of the text of the agreement is that it becomes computationally infeasible to change the text of the agreement and still maintain the same hash value. Therefore, in these instances, the parties can be confident that the representation of the agreement is the same, and the terms are the same, as those they originally agreed to, and acknowledged.

In one embodiment, at THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207, the agreement acknowledgement request message includes the first party contact data for the first party.

In one embodiment, once the second party sends an “agreement acknowledgement request message” from a second party computing system associated with the second party to a witness service provider system, or a computing system associated with another trusted third party, at THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207, process flow proceeds to THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209.

In one embodiment, at THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209 when the agreement acknowledgement request message of THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207 is received by the witness service provider system, the witness service provider system transforms the agreement acknowledgement request message into an “agreement acknowledgement message” to be sent to the first party.

In one embodiment, at THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209 one or more processors, such as CPU(s) 121 of FIG. 1, associated with the witness service provider system, such as witness service provider system 120 of FIG. 1, analyze the agreement acknowledgement request message and identify the first party contact data included in the agreement acknowledgement request message.

Returning to FIG. 2, in one embodiment, at THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209, when the agreement acknowledgement request message is received by the witness service provider system, one or more processors, such as CPU(s) 121 of FIG. 1, associated with the witness service provider system, such as witness service provider system 120 of FIG. 1, use an agreement code generation engine, such as agreement code generation engine 124 of FIG. 1, to generate a unique agreement code or symbol, typically a one-time use code or symbol, such as a string of alpha-numeric characters or symbols, and associate the generated agreement code, such as agreement code 152A of FIG. 1, with agreement acknowledgement request message data, such as agreement acknowledgement request message data 102 of FIG. 1.

Returning to FIG. 2, in one embodiment, at THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209, one or more processors, such as CPU(s) 121 of FIG. 1, associated with the witness service provider system, such as witness service provider system 120 of FIG. 1, attach the agreement code, such as agreement code 152A of FIG. 1, to the agreement acknowledgement request message data 102 of FIG. 1, thereby transforming the agreement acknowledgement request message into an “agreement acknowledgement message” including agreement acknowledgement message data 152 of FIG. 1.

Returning to FIG. 2, once the witness service provider system transforms the agreement acknowledgement request message into an “agreement acknowledgement message” to be sent to the first party at THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209 process flow proceeds to THE WITNESS SERVICE PROVIDER SYSTEM SENDS THE AGREEMENT ACKNOWLEDGEMENT MESSAGE AND AGREEMENT CODE TO THE FIRST PARTY COMPUTING SYSTEM USING THE FIRST PARTY CONTACT DATA OPERATION 211.

In one embodiment, at THE WITNESS SERVICE PROVIDER SYSTEM SENDS THE AGREEMENT ACKNOWLEDGEMENT MESSAGE AND AGREEMENT CODE TO THE FIRST PARTY COMPUTING SYSTEM USING THE FIRST PARTY CONTACT DATA OPERATION 211 the agreement acknowledgement message of THE WITNESS SERVICE PROVIDER SYSTEM RECEIVES THE AGREEMENT ACKNOWLEDGEMENT REQUEST MESSAGE AND TRANSFORMS THE AGREEMENT ACKNOWLEDGEMENT REQUEST MESSAGE INTO AN AGREEMENT ACKNOWLEDGEMENT MESSAGE BY ATTACHING AN AGREEMENT CODE OPERATION 209 is sent to the first party computing system associated with the first party using the first party contact data of THE FIRST PARTY PROVIDES THE SECOND PARTY CONTACT DATA TO BE USED TO SEND MESSAGES TO A FIRST PARTY COMPUTING SYSTEM ASSOCIATED WITH THE FIRST PARTY OPERATION 205.

In one embodiment, once the agreement acknowledgement message is sent to the first party computing system associated with the first party using the first party contact data at THE WITNESS SERVICE PROVIDER SYSTEM SENDS THE AGREEMENT ACKNOWLEDGEMENT MESSAGE AND AGREEMENT CODE TO THE FIRST PARTY COMPUTING SYSTEM USING THE FIRST PARTY CONTACT DATA OPERATION 211, process flow proceeds to THE FIRST PARTY PROVIDES THE AGREEMENT CODE INCLUDED IN THE AGREEMENT ACKNOWLEDGEMENT MESSAGE TO THE SECOND PARTY OPERATION 213.

In one embodiment, at THE FIRST PARTY PROVIDES THE AGREEMENT CODE INCLUDED IN THE AGREEMENT ACKNOWLEDGEMENT MESSAGE TO THE SECOND PARTY OPERATION 213 when the first party computing system, and therefore the first party, receives the agreement acknowledgement message, including the agreement code, of THE WITNESS SERVICE PROVIDER SYSTEM SENDS THE AGREEMENT ACKNOWLEDGEMENT MESSAGE AND AGREEMENT CODE TO THE FIRST PARTY COMPUTING SYSTEM USING THE FIRST PARTY CONTACT DATA OPERATION 211, the first party provides the agreement code to the second party.

In one embodiment, at THE FIRST PARTY PROVIDES THE AGREEMENT CODE INCLUDED IN THE AGREEMENT ACKNOWLEDGEMENT MESSAGE TO THE SECOND PARTY OPERATION 213, the agreement code, such as agreement code 152A of FIG. 1, is provided visually and/or verbally to the second party.

Returning to FIG. 2, in one embodiment, at THE FIRST PARTY PROVIDES THE AGREEMENT CODE INCLUDED IN THE AGREEMENT ACKNOWLEDGEMENT MESSAGE TO THE SECOND PARTY OPERATION 213, the agreement code is provided to the second party as agreement code data representing the agreement code.

In various embodiments, at THE FIRST PARTY PROVIDES THE AGREEMENT CODE INCLUDED IN THE AGREEMENT ACKNOWLEDGEMENT MESSAGE TO THE SECOND PARTY OPERATION 213, the agreement code is presented/transferred to the second party using any means, method, process, and/or procedure, and/or any combination of means, methods, processes, and/or procedures, of providing codes and/or data, as discussed herein, and/or as known in the art at the time of filing, and/or as developed after the time of filing.

In one embodiment, once the first party provides the agreement code to the second party at THE FIRST PARTY PROVIDES THE AGREEMENT CODE INCLUDED IN THE AGREEMENT ACKNOWLEDGEMENT MESSAGE TO THE SECOND PARTY OPERATION 213 process flow proceeds to THE AGREEMENT CODE INCLUDED IN THE AGREEMENT ACKNOWLEDGEMENT MESSAGE IS MAINTAINED AS EVIDENCE OF THE FIRST PARTY′S ACKNOWLEDGEMENT OF THE AGREEMENT OPERATION 215.

In one embodiment, at THE AGREEMENT CODE INCLUDED IN THE AGREEMENT ACKNOWLEDGEMENT MESSAGE IS MAINTAINED AS EVIDENCE OF THE FIRST PARTY′S ACKNOWLEDGEMENT OF THE AGREEMENT OPERATION 215 the agreement code, and/or agreement code data, such as agreement code data 160 of FIG. 1, is stored, or otherwise maintained, by the second party in a memory, such as memory 153 of FIG. 1, associated with a second party computing system, such as second party computing system 150 of FIG. 1, as evidence of the acknowledgement of the agreement/transaction by the first party.

Returning to FIG. 2, in one embodiment, the agreement code, and/or agreement code data, such as executed agreement code data 160 of FIG. 1, is stored, or otherwise maintained, by the first party in a memory, such as memory 103 of FIG. 1, associated with a first party computing system, such as first party computing system 100 of FIG. 1, as evidence of the acknowledgement of the agreement/transaction by the first party.

Returning to FIG. 2, in one embodiment, the agreement code, and/or agreement code data, is sent back to the witness service provider system by the second party, and/or the first party, and then the agreement code, and/or agreement code data, such as executed agreement code data 160 of FIG. 1, is stored, or otherwise maintained, by the witness service provider in a memory, such as memory 123 of FIG. 1, associated with a witness service provider system, such as witness service provider system 120 of FIG. 1, as evidence of the acknowledgement of the agreement/transaction by the first party.

Returning to FIG. 2, in one embodiment, the agreement code, and/or agreement code data, is sent back to the witness service provider system by the second party, and/or the first party, and then the agreement code, and/or agreement code data, such as executed agreement code data 160 of FIG. 1, is stored, or otherwise maintained, by the witness service provider in database, such as executed agreement data code database 170 of FIG. 1, associated with a witness service provider system, such as witness service provider system 120 of FIG. 1, as evidence of the acknowledgement of the agreement/transaction by the first party.

In one embodiment, the agreement code, and/or agreement code data, is stored by any of the parties as evidence of the acknowledgement of the agreement/transaction by the first party in a database such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In various embodiments, should a disagreement arise regarding the agreement or transaction at a future date, the agreement code, and/or agreement code data, is retrieved, along with, in one embodiment, the agreement acknowledgement message and/or the agreement/transaction representation, to be used as evidence of the agreement/transaction and/or the acknowledgement of the agreement/transaction by the first party.

In various embodiments, when the agreement acknowledgement request message of THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207 includes a representation of the agreement/transaction that allows the witness service provider, and/or one or more processors associated with the witness service provider system, to analyze the semantics of the message, the witness service provider offers additional services to either the first party or the second party.

In one embodiment, the additional services include, but are not limited to: the current balance the first party owes to the second party; a listing of all, or part, of the historical agreements/transactions between the two parties; any terms, such as a payment, or action, or date associated with one or more agreements/transactions between the two parties; a payment amount associated with one or more agreements/transactions between the two parties; and/or any other agreement/transaction related items and/or terms associated with one or more agreements/transactions between the two parties.

On the other hand, to preserve the privacy of the parties, in some embodiments, the agreement acknowledgement request message and/or agreement acknowledgement message is an opaque token that carries no discernable meaning for the witness service provider, and/or one or more processors associated with the witness service provider system. As noted above, in some embodiments, the agreement acknowledgement request message includes an indirect representation of the agreement/transaction such as a fixed length, one-way function transformation of the text of the agreement, such as a “hashed” transformation of the text of the agreement, and this process yields the private opaque token feature.

In some embodiments, the agreement acknowledgement request message of THE SECOND PARTY SENDS AN AGREEMENT ACKNOWLEDGEMENT REQUEST MESSAGE TO A WITNESS SERVICE PROVIDER SYSTEM THAT INCLUDES A REPRESENTATION OF THE AGREEMENT AND THE FIRST PARTY CONTACT DATA OPERATION 207 is sent by the second party to a different witness service provider system, or receiving unit, associated with the witness service provider depending on the type of agreement/transaction involved.

As an example, in one embodiment, a different witness service provider system, or receiving unit, or code, is established by the witness service provider for different types of agreements/transactions such as store credit, order of goods or service, equipment lease, etc.

Alternatively, in some embodiments, a single witness service provider system, or receiving unit, or code, is used for all kinds of agreements/transactions and further differentiation is achieved by explicit analysis and classification of the body of the agreement acknowledgement request message by the witness service provider system.

In one embodiment, once the agreement code, and/or agreement code data, is stored by any of the parties as evidence of the acknowledgement of the agreement/transaction by the first party at THE AGREEMENT CODE INCLUDED IN THE AGREEMENT ACKNOWLEDGEMENT MESSAGE IS MAINTAINED AS EVIDENCE OF THE FIRST PARTY′S ACKNOWLEDGEMENT OF THE AGREEMENT OPERATION 215 process flow proceeds to EXIT OPERATION 231.

In one embodiment at EXIT OPERATION 231 process for providing an agreement witness service 200 is exited to await new data.

Using process for providing an agreement witness service 200, parties desiring to enter into an agreement are provided a lightweight and simple mechanism for recording their acknowledgement of the agreement through a trusted, and disinterested, third party witness service provider. Therefore, using process for providing an agreement witness service 200, the acknowledgement of the agreement/transaction by both parties is recorded for use as evidence, if needed, but neither party needs to take the time and energy to manually record the agreement/transaction.

In addition, using process for providing an agreement witness service 200, the acknowledgement, and/or proof, of the agreement is provided without overly formal or burdensome promissory, and/or contract-like, mechanisms that, in some regions and cultures, would indicate a lack of trust and therefore interfere with personal business relationships.

As a result, using process for providing an agreement witness service 200, much of the risk associated with current informal agreements/transactions can be eliminated while still preserving the flexibility and personal trust elements that are critical to these traditional and time-honored agreements/transactions.

In addition, one embodiment of the method and system for providing an agreement witness service discussed herein is implemented using an SMS communication infrastructure capable of being accessed and used through mobile devices, such as mobile phones, which are far more common and accessible in many parts of the world than traditional computing systems and Internet access.

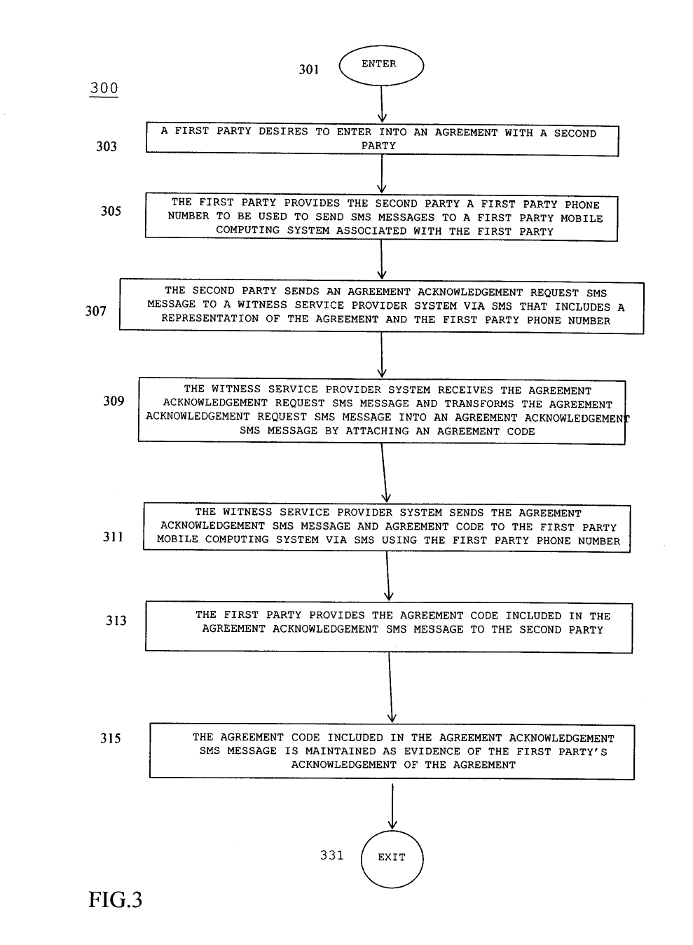

FIG. 3 a flow chart depicting an SMS-based process for providing an agreement witness service 300 in accordance with one embodiment. Process for providing an agreement witness service 300 begins at ENTER OPERATION 301 of FIG. 3 and process flow proceeds to A FIRST PARTY DESIRES TO ENTER INTO AN AGREEMENT WITH A SECOND PARTY OPERATION 303.

In one embodiment, at A FIRST PARTY DESIRES TO ENTER INTO AN AGREEMENT WITH A SECOND PARTY OPERATION 303 a first party, such as a customer or other “accepting party”, desires to enter into an agreement/transaction, such as, but not limited to, a credit transaction, a special order, a rental agreement, or any other form of agreement or transaction, with a second party, such as a merchant or other “proposing party”.

In one embodiment, once a first party decides to enter into an agreement/transaction with a second party at A FIRST PARTY DESIRES TO ENTER INTO AN AGREEMENT WITH A SECOND PARTY OPERATION 303 process flow proceeds to THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305.

In one embodiment, at THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305 the first party of A FIRST PARTY DESIRES TO ENTER INTO AN AGREEMENT WITH A SECOND PARTY OPERATION 303 provides the second party of A FIRST PARTY DESIRES TO ENTER INTO AN AGREEMENT WITH A SECOND PARTY OPERATION 303 a phone number that will be used to send one or more Short Message Service (SMS) messages to a first party computing system associated with the first party, such as a mobile computing system, or mobile phone, that is SMS capable.

Herein, the term mobile computing system includes, but is not limited to, any mobile computing system as discussed herein, and/or as known in the art at the time of filing, and/or as developed after the time of filing.

In one embodiment, once the first party provides the second party a phone number that will be used to send one or more Short Message Service (SMS) messages to a first party computing system associated with the first party at THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305, process flow proceeds to THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307.

In one embodiment, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307 at the time of the agreement/transaction, the second party sends an “agreement acknowledgement request SMS message” from a SMS capable second party computing system associated with the second party to a witness service provider system, or a computing system associated with another trusted third party.

In one embodiment, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307, the agreement acknowledgement request SMS message includes a direct representation of the agreement/transaction, such as a number/amount associated with the agreement/transaction or a short statement of the agreement/transaction in SMS format.

In one embodiment, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307, the agreement acknowledgement request SMS message includes an indirect representation of the agreement/transaction such as a fixed length, one-way function transformation of the text of the agreement, such as a “hashed” transformation of the text of the agreement in an SMS format. In one embodiment, the indirect representation is generated by a software application on the second party's computing system.

One advantage to providing a one-way function transformation of the text of the agreement is that it becomes computationally infeasible to change the text of the agreement and still maintain the same hash value. Therefore, in these instances, the parties can be confident that the representation of the agreement is the same, and the terms are the same, as those they originally agreed to, and acknowledged.

In one embodiment, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307, the agreement acknowledgement request SMS message includes the first party phone number that will be used to send one or more Short Message Service (SMS) messages to a first party computing system associated with the first party.

In one embodiment, once the second party sends an “agreement acknowledgement request SMS message” from a second party computing system associated with the second party to a witness service provider system, or a computing system associated with another trusted third party, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307, process flow proceeds to THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309.

In one embodiment, at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309 when the agreement acknowledgement request SMS message of THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307 is received by the witness service provider system, the witness service provider system transforms the agreement acknowledgement request SMS message into an “agreement acknowledgement SMS message” to be sent to the first party.

In one embodiment, at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309 one or more processors, such as CPU(s) 121 of FIG. 1, associated with the witness service provider system, such as witness service provider system 120 of FIG. 1, analyze the agreement acknowledgement request SMS message and identify the first party phone number included in the agreement acknowledgement request SMS message.

Returning to FIG. 3, in one embodiment, at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309, when the agreement acknowledgement request SMS message is received by the witness service provider system, one or more processors, such as CPU(s) 121 of FIG. 1, associated with the witness service provider system, such as witness service provider system 120 of FIG. 1, use an agreement code generation engine, such as agreement code generation engine 124 of FIG. 1, to generate a unique agreement code or symbol, typically a one-time use code or symbol, such as a string of alpha-numeric characters or symbols, and associate the generated agreement code, such as agreement code 152A of FIG. 1, with agreement acknowledgement request SMS message data, such as agreement acknowledgement request message data 102 of FIG. 1.

Returning to FIG. 3, in one embodiment, at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309, one or more processors, such as CPU(s) 121 of FIG. 1, associated with the witness service provider system, such as witness service provider system 120 of FIG. 1, attach the agreement code, such as agreement code 152A of FIG. 1, to the agreement acknowledgement request message data 102 of FIG. 1, thereby transforming the agreement acknowledgement request SMS message into an “agreement acknowledgement SMS message” including agreement acknowledgement message data 152 of FIG. 1.

Returning to FIG. 3, once the witness service provider system transforms the agreement acknowledgement request SMS message into an “agreement acknowledgement SMS message” to be sent to the first party at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309 process flow proceeds to THE WITNESS SERVICE PROVIDER SYSTEM SENDS THE AGREEMENT ACKNOWLEDGEMENT SMS MESSAGE AND AGREEMENT CODE TO THE FIRST PARTY MOBILE COMPUTING SYSTEM VIA SMS USING THE FIRST PARTY PHONE NUMBER OPERATION 311.

In one embodiment, at THE WITNESS SERVICE PROVIDER SYSTEM SENDS THE AGREEMENT ACKNOWLEDGEMENT SMS MESSAGE AND AGREEMENT CODE TO THE FIRST PARTY MOBILE COMPUTING SYSTEM VIA SMS USING THE FIRST PARTY PHONE NUMBER OPERATION 311 the agreement acknowledgement SMS message of THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309 is sent to the first party mobile computing system associated with the first party using the first party phone number of THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305.

In one embodiment, once the agreement acknowledgement SMS message is sent to the first party mobile computing system associated with the first party using the first party phone number at THE WITNESS SERVICE PROVIDER SYSTEM SENDS THE AGREEMENT ACKNOWLEDGEMENT SMS MESSAGE AND AGREEMENT CODE TO THE FIRST PARTY MOBILE COMPUTING SYSTEM VIA SMS USING THE FIRST PARTY PHONE NUMBER OPERATION 311, process flow proceeds to THE FIRST PARTY PROVIDES THE AGREEMENT CODE INCLUDED IN THE AGREEMENT ACKNOWLEDGEMENT SMS MESSAGE TO THE SECOND PARTY OPERATION 313.

In one embodiment, at THE FIRST PARTY PROVIDES THE AGREEMENT CODE INCLUDED IN THE AGREEMENT ACKNOWLEDGEMENT SMS MESSAGE TO THE SECOND PARTY OPERATION 313 when the first party mobile computing system, and therefore the first party, receives the agreement acknowledgement SMS message, including the agreement code, of THE WITNESS SERVICE PROVIDER SYSTEM SENDS THE AGREEMENT ACKNOWLEDGEMENT SMS MESSAGE AND AGREEMENT CODE TO THE FIRST PARTY MOBILE COMPUTING SYSTEM VIA SMS USING THE FIRST PARTY PHONE NUMBER OPERATION 311, the first party provides the agreement code to the second party of THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305.

In one embodiment, at THE FIRST PARTY PROVIDES THE AGREEMENT CODE INCLUDED IN THE AGREEMENT ACKNOWLEDGEMENT SMS MESSAGE TO THE SECOND PARTY OPERATION 313, the agreement code, such as agreement code 152A of FIG. 1, is provided visually and/or verbally to the second party.

Returning to FIG. 3, in one embodiment, at THE FIRST PARTY PROVIDES THE AGREEMENT CODE INCLUDED IN THE AGREEMENT ACKNOWLEDGEMENT SMS MESSAGE TO THE SECOND PARTY OPERATION 313, the agreement code is provided to the second party as agreement code data representing the agreement code.

In various embodiments, at THE FIRST PARTY PROVIDES THE AGREEMENT CODE INCLUDED IN THE AGREEMENT ACKNOWLEDGEMENT SMS MESSAGE TO THE SECOND PARTY OPERATION 313, the agreement code is presented/transferred to the second party using any means, method, process, and/or procedure, and/or any combination of means, methods, processes, and/or procedures, of providing codes and/or data, as discussed herein, and/or as known in the art at the time of filing, and/or as developed after the time of filing.

In one embodiment, once the first party provides the agreement code to the second party at THE FIRST PARTY PROVIDES THE AGREEMENT CODE INCLUDED IN THE AGREEMENT ACKNOWLEDGEMENT SMS MESSAGE TO THE SECOND PARTY OPERATION 313 process flow proceeds to THE AGREEMENT CODE INCLUDED IN THE AGREEMENT ACKNOWLEDGEMENT SMS MESSAGE IS MAINTAINED AS EVIDENCE OF THE FIRST PARTY′S ACKNOWLEDGEMENT OF THE AGREEMENT OPERATION 315.

In one embodiment, at THE AGREEMENT CODE INCLUDED IN THE AGREEMENT ACKNOWLEDGEMENT SMS MESSAGE IS MAINTAINED AS EVIDENCE OF THE FIRST PARTY′S ACKNOWLEDGEMENT OF THE AGREEMENT OPERATION 315 the agreement code, and/or agreement code data, such as agreement code data 160 of FIG. 1, is stored, or otherwise maintained, by the second party in a memory, such as memory 153 of FIG. 1, associated with a second party computing system, such as second party computing system 150 of FIG. 1, as evidence of the acknowledgement of the agreement/transaction by the first party.

Returning to FIG. 3, in one embodiment, the agreement code, and/or agreement code data, such as executed agreement code data 160 of FIG. 1, is stored, or otherwise maintained, by the first party in a memory, such as memory 103 of FIG. 1, associated with a first party computing system, such as first party computing system 100 of FIG. 1, as evidence of the acknowledgement of the agreement/transaction by the first party.

Returning to FIG. 3, in one embodiment, the agreement code, and/or agreement code data, is sent back to the witness service provider system by the second party, and/or the first party, and then the agreement code, and/or agreement code data, such as executed agreement code data 160 of FIG. 1, is stored, or otherwise maintained, by the witness service provider in a memory, such as memory 123 of FIG. 1, associated with a witness service provider system, such as witness service provider system 120 of FIG. 1, as evidence of the acknowledgement of the agreement/transaction by the first party.

Returning to FIG. 3, in one embodiment, the agreement code, and/or agreement code data, is sent back to the witness service provider system by the second party, and/or the first party, and then the agreement code, and/or agreement code data, such as executed agreement code data 160 of FIG. 1, is stored, or otherwise maintained, by the witness service provider in database, such as executed agreement data code database 170 of FIG. 1, associated with a witness service provider system, such as witness service provider system 120 of FIG. 1, as evidence of the acknowledgement of the agreement/transaction by the first party.

In one embodiment, the agreement code, and/or agreement code data, is stored by any of the parties as evidence of the acknowledgement of the agreement/transaction by the first party in a database such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In various embodiments, should a disagreement arise regarding the agreement or transaction at a future date, the agreement code, and/or agreement code data, is retrieved, along with, in one embodiment, the agreement acknowledgement SMS message and/or the agreement/transaction representation, to be used as evidence of the agreement/transaction and/or the acknowledgement of the agreement/transaction by the first party.

In one embodiment, once the agreement code, and/or agreement code data, is stored by any of the parties as evidence of the acknowledgement of the agreement/transaction by the first party at THE AGREEMENT CODE INCLUDED IN THE AGREEMENT ACKNOWLEDGEMENT SMS MESSAGE IS MAINTAINED AS EVIDENCE OF THE FIRST PARTY′S ACKNOWLEDGEMENT OF THE AGREEMENT OPERATION 315, process flow proceeds to EXIT OPERATION 331. In one embodiment, at EXIT OPERATION 331 process for providing an agreement witness service is exited to await new data.

In various embodiments, when the agreement acknowledgement request SMS message of THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307 includes a representation of the agreement/transaction that allows the witness service provider, and/or one or more processors associated with the witness service provider system, to analyze the semantics of the message, the witness service provider offers additional services to either the first party or the second party.

In one embodiment, the additional services include, but are not limited to: the current balance the first party owes to the second party; a listing of all, or part, of the historical agreements/transactions between the two parties; any terms, such as a payment, or action, or date associated with one or more agreements/transactions between the two parties; a payment amount associated with one or more agreements/transactions between the two parties; and/or any other agreement/transaction related items and/or terms associated with one or more agreements/transactions between the two parties.

On the other hand, to preserve the privacy of the parties, in some embodiments, the agreement acknowledgement request SMS message and/or agreement acknowledgement SMS message is an opaque token that carries no discernable meaning for the witness service provider, and/or one or more processors associated with the witness service provider system. As noted above, in some embodiments, the agreement acknowledgement request SMS message includes an indirect representation of the agreement/transaction such as a fixed length, one-way function transformation of the text of the agreement, such as a “hashed” transformation of the text of the agreement in SMS format, and this process yields the private opaque token feature.

In some embodiments, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307 the agreement acknowledgement request SMS message is sent by the second party to a different short code associated with witness service provider system depending on the type of agreement/transaction involved.

As an example, in one embodiment a different short code is established by the witness service provider for different types of agreements/transactions such as store credit, order of goods or service, equipment lease, etc.

Alternatively, in some embodiments, a single short code is used for all kinds of agreements/transactions and further differentiation is achieved by explicit analysis and classification of the body of the agreement acknowledgement request SMS message by the witness service provider system.

As a specific illustrative example of the implementation and use of one embodiment of process for providing an agreement witness service 300, assume a local convenience store, i.e., a merchant, in South-East Asia is willing to extend a credit to a customer.

In this specific illustrative example, at THE FIRST PARTY PROVIDES THE SECOND PARTY A FIRST PARTY PHONE NUMBER TO BE USED TO SEND SMS MESSAGES TO A FIRST PARTY MOBILE COMPUTING SYSTEM ASSOCIATED WITH THE FIRST PARTY OPERATION 305 the customer provides the merchant a mobile phone number for the customer and, at THE SECOND PARTY SENDS AN AGREEMENT ACKNOWLEDGEMENT REQUEST SMS MESSAGE TO A WITNESS SERVICE PROVIDER SYSTEM VIA SMS THAT INCLUDES A REPRESENTATION OF THE AGREEMENT AND THE FIRST PARTY PHONE NUMBER OPERATION 307, the merchant sends an “agreement acknowledgement request SMS message” to a witness service provider system via SMS.

In this specific example, the agreement acknowledgement request SMS message includes a direct or indirect representation of the agreement/transaction and the customer mobile phone number for the customer mobile computing system in SMS text format. In one embodiment, the agreement acknowledgement request SMS message includes simply the first party's identification, customer mobile phone number, and an amount associated with the agreement/transaction.

In this specific example, when the agreement acknowledgement request SMS message is received by the witness service provider system at THE WITNESS SERVICE PROVIDER SYSTEM RECEIVES THE AGREEMENT ACKNOWLEDGEMENT REQUEST SMS MESSAGE AND TRANSFORMS THE AGREEMENT ACKNOWLEDGEMENT REQUEST SMS MESSAGE INTO AN AGREEMENT ACKNOWLEDGEMENT SMS MESSAGE BY ATTACHING AN AGREEMENT CODE OPERATION 309, the customer mobile phone number included in the agreement acknowledgement request SMS message is identified and a unique agreement code is generated and associated with the agreement acknowledgement request SMS message.

In this specific example, the agreement code is then attached to the agreement acknowledgement request SMS message, thereby transforming the agreement acknowledgement request SMS message into an “agreement acknowledgement SMS message”, and at THE WITNESS SERVICE PROVIDER SYSTEM SENDS THE AGREEMENT ACKNOWLEDGEMENT SMS MESSAGE AND AGREEMENT CODE TO THE FIRST PARTY MOBILE COMPUTING SYSTEM VIA SMS USING THE FIRST PARTY PHONE NUMBER OPERATION 311 the agreement acknowledgement SMS message is sent to the customer mobile computing system using the customer mobile phone number.

In this specific example, when the customer receives the agreement acknowledgement SMS message including the agreement code, at THE FIRST PARTY PROVIDES THE AGREEMENT CODE INCLUDED IN THE AGREEMENT ACKNOWLEDGEMENT SMS MESSAGE TO THE SECOND PARTY OPERATION 313 the customer provides the agreement code to the merchant and at THE AGREEMENT CODE INCLUDED IN THE AGREEMENT ACKNOWLEDGEMENT SMS MESSAGE IS MAINTAINED AS EVIDENCE OF THE FIRST PARTY′S ACKNOWLEDGEMENT OF THE AGREEMENT OPERATION 315 the agreement code is stored, or otherwise maintained, by any, or all, of the parties as evidence of the acknowledgement of the agreement/transaction by the customer.

Using process for providing an agreement witness service 300, parties desiring to enter into an agreement are provided a lightweight and SMS-based mechanism for recording their acknowledgement of the agreement through a trusted, and disinterested, third party witness service provider. Therefore, using the method and system for providing an agreement witness service discussed herein, the acknowledgement of the agreement/transaction by both parties is recorded for use as evidence, if needed, but neither party needs to take the time and energy to manually record the agreement/transaction.

In addition, process for providing an agreement witness service 300, the acknowledgement, and/or proof, of the agreement is provided via SMS without overly formal or burdensome promissory, and/or contract-like, mechanisms that, in some regions and cultures, would indicate a lack of trust and therefore interfere with personal business relationships.

As a result, using process for providing an agreement witness service 300, much of the risk associated with current informal agreements/transactions can be eliminated while still preserving the flexibility and personal trust elements that are critical to these traditional and time-honored agreements/transactions, and through an SMS infrastructure which is capable of being accessed and used through mobile devices, such as mobile phones, that are far more common and accessible in many parts of the world than traditional computing systems and Internet access.

In the discussion above, certain aspects of one embodiment include process steps or operations or instructions described herein for illustrative purposes in a particular order or grouping. However, the particular order or grouping shown and discussed herein is illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein does not limit the scope of the invention as claimed below.

As discussed in more detail above, using the above embodiments, with little or no modification and/or consumer input, there is considerable flexibility, adaptability, and opportunity for customization to meet the specific needs of various consumers under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols.

Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “activating”, “accessing”, “applying”, “analyzing”, “calculating”, “capturing”, “categorizing”, “classifying”, “comparing”, “defining”, “detecting”, “determining”, “distributing”, “encrypting”, “extracting”, “filtering”, “forwarding”, “generating”, “identifying”, “implementing”, “monitoring”, “obtaining”, “processing”, “providing”, “receiving”, “requesting”, “saving”, “sending”, “storing”, “transferring”, “transforming”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations.

In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet, or a cloud.

Therefore, numerous variations, whether explicitly provided for by the specification or implied by the specification or not, may be implemented by one of skill in the art in view of this disclosure.

What is claimed is:

1. A computing system implemented process for providing an agreement witness service comprising:
a first party and a second party deciding to enter an agreement;
the first party providing the second party contact data for the first party to be used to send one or more communications to a first party computing system associated with the first party;
the second party using one or more processors associated with one or more computing systems to generate and an agreement acknowledgement request message, the agreement acknowledgement request message including a representation of at least part of the agreement and the first party contact data;
the second party using one or more processors associated with one or more computing systems to send the agreement acknowledgement request message to a witness service provider system;
the witness service provider system using one or more processors associated with one or more computing systems to generate an agreement code to be associated with the agreement acknowledgement request message;
the witness service provider system using one or more processors associated with one or more computing systems to attach the agreement code to the agreement acknowledgement request message, thereby transforming the agreement acknowledgement request message into an agreement acknowledgement message;
the witness service provider system using one or more processors associated with one or more computing systems to send the agreement acknowledgement message to the first party computing system using the contact data for the first party included in the agreement acknowledgement request message;
the first party receiving the agreement acknowledgement message through the first party computing system;
the first party obtaining the agreement code from the agreement acknowledgement message;
the first party providing the agreement code from the agreement acknowledgement message to the second party; and
maintaining the data representing the agreement code as evidence of the first party acknowledging the agreement of the agreement acknowledgement request message.

2. The computing system implemented process for providing an agreement witness service of claim 1, wherein;
the first party is a customer of the second party who is a merchant; and
the agreement is a credit transaction agreement.

3. The computing system implemented process for providing an agreement witness service of claim 1, wherein;
the agreement acknowledgement request message includes a direct representation of at least part of the agreement and the first party contact data.

4. The computing system implemented process for providing an agreement witness service of claim 1, wherein;
the agreement acknowledgement request message includes an indirect representation of at least part of the agreement and the first party contact data.

5. The computing system implemented process for providing an agreement witness service of claim 1, wherein;
the agreement code is selected from the group of code types consisting of:
a one-time use code;
a randomly generated code;
one or more alpha-numeric symbols; and
one or more visual symbols or figures.

6. The computing system implemented process for providing an agreement witness service of claim 1, wherein;
the data representing the agreement code is maintained as evidence of the first party acknowledging the agreement of the agreement acknowledgement request message by the second party.

7. The computing system implemented process for providing an agreement witness service of claim 1, wherein;
the data representing the agreement code is maintained as evidence of the first party acknowledging the agreement of the agreement acknowledgement request message by the witness service provider.

8. A Short Message System (SMS) implemented process for providing an agreement witness service comprising:
a first party and a second party deciding to enter an agreement;
the first party providing the second party a phone number for the first party to be used to send one or more SMS messages to a first party SMS capable mobile computing system associated with the first party;
the second party using a second party SMS capable mobile computing system associated with the second party to generate and an agreement acknowledgement request SMS message, the agreement acknowledgement request SMS message including a representation of at least part of the agreement and the phone number for the first party;
the second party using the second party SMS capable mobile computing system to send the agreement acknowledgement request SMS message to a witness service provider system;
the witness service provider system using one or more processors associated with one or more computing systems to generate an agreement code to be associated with the agreement acknowledgement request SMS message;
the witness service provider system using one or more processors associated with one or more computing systems to attach the agreement code to the agreement acknowledgement request SMS message, thereby transforming the agreement acknowledgement request SMS message into an agreement acknowledgement SMS message;
the witness service provider system using one or more processors associated with one or more computing systems to send the agreement acknowledgement SMS message to the first party SMS capable mobile computing system using the phone number for the first party included in the agreement acknowledgement request SMS message;
the first party receiving the agreement acknowledgement SMS message through the first party SMS capable mobile computing system;
the first party obtaining the agreement code from the agreement acknowledgement SMS message;
the first party providing the agreement code from the agreement acknowledgement SMS message to the second party; and
maintaining the data representing the agreement code as evidence of the first party acknowledging the agreement of the agreement acknowledgement request SMS message.

9. The Short Message System (SMS) implemented process for providing an agreement witness service of claim 8, wherein;
the first party is a customer of the second party who is a merchant; and
the agreement is a credit transaction agreement.

10. The Short Message System (SMS) implemented process for providing an agreement witness service of claim 8, wherein;
the agreement acknowledgement request SMS message includes a direct representation of at least part of the agreement and the phone number for the first party.

11. The Short Message System (SMS) implemented process for providing an agreement witness service of claim 8, wherein;
the agreement acknowledgement request SMS message includes an indirect representation of at least part of the agreement and the phone number for the first party.

12. The Short Message System (SMS) implemented process for providing an agreement witness service of claim 8, wherein;
the agreement code is selected from the group of code types consisting of:
a one-time use code;
a randomly generated code;
one or more alpha-numeric symbols; and
one or more visual symbols or figures.

13. The Short Message System (SMS) implemented process for providing an agreement witness service of claim 8, wherein;
the data representing the agreement code is maintained as evidence of the first party acknowledging the agreement of the agreement acknowledgement request SMS message by the second party.

14. The Short Message System (SMS) implemented process for providing an agreement witness service of claim 8, wherein;
the data representing the agreement code is maintained as evidence of the first party acknowledging the agreement of the agreement acknowledgement request SMS message by the witness service provider.

15. The Short Message System (SMS) implemented process for providing an agreement witness service of claim 8, wherein;
the second party uses the second party SMS capable mobile computing system to send the agreement acknowledgement request SMS message to a short-code associated with the witness service provider system.

16. The Short Message System (SMS) implemented process for providing an agreement witness service of claim 8, wherein;
the witness service provider system provides two or more agreement specific short codes each associated with one of two or more agreement types; and
the second party uses the second party SMS capable mobile computing system to send the agreement acknowledgement request SMS message to an agreement specific short code associated with the agreement type of the of the agreement acknowledgement request SMS message.

17. A system for providing an agreement witness service comprising:
a first party computing system accessible by a first party;
a second party computing system accessible by a second party;
a witness service provider system, the witness service provider system including an agreement generation engine and one or more processors associated with the witness service provider system, the one or more processors associated with the witness service provider system for implementing at least a portion of a process for providing an agreement witness service, the process for providing an agreement witness service comprising:
the first party providing the second party contact data for the first party to be used to send one or more communications to the first party computing system;
the second party using the second party computing system to generate and an agreement acknowledgement request message, the agreement acknowledgement request message including a representation of at least part of an agreement between the first party and the second party and the contact data for the first party;
the second party using the second party computing system to send the agreement acknowledgement request message to the witness service provider system;
the witness service provider system using the one or more processors associated with the witness service provider system to generate an agreement code to be associated with the agreement acknowledgement request message;
the witness service provider system using the one or more processors associated with the witness service provider system to attach the agreement code to the agreement acknowledgement request message, thereby transforming the agreement acknowledgement request message into an agreement acknowledgement message;
the witness service provider system using the one or more processors associated with the witness service provider system to send the agreement acknowledgement message to the first party computing system using the contact data for the first party included in the agreement acknowledgement request message;
the first party receiving the agreement acknowledgement message through the first party computing system;
the first party obtaining the agreement code from the agreement acknowledgement message;
the first party providing the agreement code from the agreement acknowledgement message to the second party; and
maintaining the data representing the agreement code as evidence of the first party acknowledging the agreement of the agreement acknowledgement request message.

18. The system for providing an agreement witness service of claim 17, wherein;
the first party is a customer of the second party who is a merchant; and
the agreement is a credit transaction agreement.

19. The system for providing an agreement witness service of claim 17, wherein;
the agreement acknowledgement request message includes a direct representation of at least part of the agreement and the first party contact data.

20. The system for providing an agreement witness service of claim 17, wherein;
the agreement acknowledgement request message includes an indirect representation of at least part of the agreement and the first party contact data.

21. The system for providing an agreement witness service of claim 17, wherein;
the agreement code is selected from the group of code types consisting of:
a one-time use code;
a randomly generated code;
one or more alpha-numeric symbols; and
one or more visual symbols or figures.

22. The system for providing an agreement witness service of claim 17, wherein;
the data representing the agreement code is maintained as evidence of the first party acknowledging the agreement of the agreement acknowledgement request message by the second party.

23. The system for providing an agreement witness service of claim 17, wherein;
the data representing the agreement code is maintained as evidence of the first party acknowledging the agreement of the agreement acknowledgement request message by the witness service provider.

24. A system for providing an SMS agreement witness service comprising:
a first party SMS capable mobile computing system accessible by a first party;
a second party SMS capable mobile computing system accessible by a second party;
a witness service provider system, the witness service provider system including an agreement generation engine and one or more processors associated with the witness service provider system, the one or more processors associated with the witness service provider system for implementing at least a portion of a Short Message System (SMS) implemented process for providing an agreement witness service, the Short Message System (SMS) implemented process for providing an agreement witness service comprising:
the first party providing the second party a phone number to be used to send one or more SMS messages to the first party SMS capable mobile computing system;
the second party using the second party SMS capable mobile computing system to generate and an agreement acknowledgement request SMS message, the agreement acknowledgement request SMS message including a representation of at least part of the agreement and the phone number for the first party;
the second party using the second party SMS capable mobile computing system to send the agreement acknowledgement request SMS message to a witness service provider system;
the witness service provider system using the one or more processors associated with the witness service provider system to generate an agreement code to be associated with the agreement acknowledgement request SMS message;
the witness service provider system using the one or more processors associated with the witness service provider system to attach the agreement code to the agreement acknowledgement request SMS message, thereby transforming the agreement acknowledgement request SMS message into an agreement acknowledgement SMS message;
the witness service provider system using the one or more processors associated with the witness service provider system to send the agreement acknowledgement SMS message to the first party SMS capable mobile computing system using the phone number for the first party included in the agreement acknowledgement request SMS message;
the first party receiving the agreement acknowledgement SMS message through the first party SMS capable mobile computing system;
the first party obtaining the agreement code from the agreement acknowledgement SMS message;
the first party providing the agreement code from the agreement acknowledgement SMS message to the second party; and
maintaining the data representing the agreement code as evidence of the first party acknowledging the agreement of the agreement acknowledgement request SMS message.

25. The system for providing an SMS agreement witness service of claim 24, wherein;
the first party is a customer of the second party who is a merchant; and
the agreement is a credit transaction agreement.

26. The system for providing an SMS agreement witness service of claim 24, wherein;
the agreement acknowledgement request SMS message includes a direct representation of at least part of the agreement and the phone number for the first party.

27. The system for providing an SMS agreement witness service of claim 24, wherein;
the agreement acknowledgement request SMS message includes an indirect representation of at least part of the agreement and the phone number for the first party.

28. The system for providing an SMS agreement witness service of claim 24, wherein;
the agreement code is selected from the group of code types consisting of:
a one-time use code;
a randomly generated code;
one or more alpha-numeric symbols; and
one or more visual symbols or figures.

29. The system for providing an SMS agreement witness service of claim 24, wherein;
the data representing the agreement code is maintained as evidence of the first party acknowledging the agreement of the agreement acknowledgement request SMS message by the second party.

30. The system for providing an SMS agreement witness service of claim 24, wherein;
the data representing the agreement code is maintained as evidence of the first party acknowledging the agreement of the agreement acknowledgement request SMS message by the witness service provider.

31. The system for providing an SMS agreement witness service of claim 24, wherein;
the second party uses the second party SMS capable mobile computing system to send the agreement acknowledgement request SMS message to a short-code associated with the witness service provider system.

32. The system for providing an SMS agreement witness service of claim 24, wherein;
the witness service provider system provides two or more agreement specific short codes each associated with one of two or more agreement types; and
the second party uses the second party SMS capable mobile computing system to send the agreement acknowledgement request SMS message to an agreement specific short code associated with the agreement type of the of the agreement acknowledgement request SMS message.
